(19) United States
(12) Patent Application Publication
(10) Pub. No.: US 2023/0066706 A1
(43) Pub. Date: Mar. 2, 2023

(54) SYSTEM AND METHOD FOR MACHINE LEARNING ARCHITECTURE WITH A MEMORY MANAGEMENT MODULE

(71) Applicant: ROYAL BANK OF CANADA, Toronto (CA)

(72) Inventors: Hasham BURHANI, Oshawa (CA); Xiao Qi SHI, Richmond Hill (CA); Kiarash JAMALI, Toronto (CA)

(21) Appl. No.: 17/411,666

(22) Filed: Aug. 25, 2021

(51) Int. Cl. G06Q 30/02; G06N 20/00; G06N 5/04

(52) U.S. Cl. CPC G06Q 30/0201; G06N 20/00; G06N 5/043

(57) ABSTRACT

Systems, devices, and methods for training an automated agent are disclosed. Multiple automated agents are instantiated, each of the automated agents configured to train over a plurality of training cycles. For each resource, a dedicated portion of a memory device to store state data for the respective resource is allocated. The method includes receiving a request for state data for a particular resource from a subset of the automated agents; for each of the training cycles for the subset of the plurality of automated agents, storing updated state data for the particular resource in the dedicated portion of the memory device allocated to the particular resource; and transmitting an address of the dedicated portion of the memory device for the particular resource to the subset of the automated agents, to facilitate asynchronous reading of the stored state data for the particular resource during each training cycle.

### FIELD

The present disclosure generally relates to the field of computer processing and reinforcement learning.

### BACKGROUND

A reinforcement learning neural network can be trained to optimize, generate or execute resource task requests. Input data for training a reinforcement learning neural network can include state data, and learning by reinforcement learning based on the state data in real time or near real time can require a large amount of data being transmitted between various system processes and components in each training cycle. Such inter-process and inter-component data transmission can be slow, especially over a TCP/IP internet protocol.

### SUMMARY

In an aspect, there is provided a computer-implemented system for training an automated agent. The system includes a communication interface; at least one processor; memory in communication with the at least one processor; and software code stored in the memory. The software code, when executed at the at least one processor causes the system to: instantiate a plurality of automated agents for generating resource task requests for a plurality of resources, each of the automated agents configured to train over a plurality of training cycles; for each resource of the plurality of resources, allocate a dedicated portion of a memory device to store state data for the respective resource; receive a request for state data for a particular resource from a subset of the plurality of automated agents; for each of the training cycles for the subset of the plurality of automated agents, store updated state data for the particular resource in the dedicated portion of the memory device allocated to the particular resource; and transmit an address of the dedicated portion of the memory device for the particular resource to the subset of the automated agents, to facilitate asynchronous reading of the stored state data for the particular resource during each training cycle.

In some embodiments, the updated state data for the particular resource includes current state data for the particular resource in an environment in which the resource task requests are made.

In some embodiments, the updated state data for the particular resource further includes historical state data for the particular resource in the environment in which the resource task requests are made.

In some embodiments, the current state data for the particular resource is appended to the historical state data for the particular resource during each training cycle at the dedicated portion of the memory device allocated to the particular resource.

In some embodiments, the software code, when executed at the at least one processor further causes the system to: process the updated state data for the particular resource into a specific format for the memory device prior to storing the updated state data in the dedicated portion of the memory device allocated to the particular resource.

In some embodiments, the software code, when executed at the at least one processor causes the system to: store updated state data for each of the plurality of resources in the dedicated portion of the memory device to for the respective resource.

In some embodiments, the current state data for the particular resource includes a market price of the particular resource.

In some embodiments, the environment includes at least one trading venue.

In accordance with another aspect, there is provided a computer-implemented method for training an automated agent, the method may include: instantiating a plurality of automated agents for generating resource task requests for a plurality of resources, each of the automated agents configured to train over a plurality of training cycles; for each resource of the plurality of resources, allocating a dedicated portion of a memory device to store state data for the respective resource; receiving a request for state data for a particular resource from a subset of the plurality of automated agents; for each of the training cycles for the subset of the plurality of automated agents, storing updated state data for the particular resource in the dedicated portion of the memory device allocated to the particular resource; and transmitting an address of the dedicated portion of the memory device for the particular resource to the subset of the automated agents, to facilitate asynchronous reading of the stored state data for the particular resource during each training cycle.

In some embodiments, the updated state data for the particular resource includes current state data for the particular resource in an environment in which the resource task requests are made.

In some embodiments, the updated state data for the particular resource further includes historical state data for the particular resource in the environment in which the resource task requests are made.

In some embodiments, storing updated state data for the particular resource in the dedicated portion of the memory device includes appending the current state data for the particular resource to the historical state data for the particular resource during each training cycle at the dedicated portion of the memory device allocated to the particular resource.

In some embodiments, the method may further include, prior to storing the updated state data in the dedicated portion of the memory device allocated to the particular resource: processing the updated state data for the particular resource into a specific format for the memory device.

In some embodiments, the method may include: storing updated state data for each of the plurality of resources in the dedicated portion of the memory device to for the respective resource.

In some embodiments, the current state data for the particular resource includes a market price of the particular resource.

In some embodiments, the environment includes at least one trading venue.

In accordance with yet another aspect, there is a non-transitory computer-readable storage medium storing instructions which when executed adapt at least one computing device to: instantiate a plurality of automated agents for generating resource task requests for a plurality of resources, each of the automated agents configured to train over a plurality of training cycles; for each resource of the plurality of resources, allocate a dedicated portion of a memory device to store state data for the respective resource; receive a request for state data for a particular resource from a subset of the plurality of automated agents; for each of the training cycles for the subset of the plurality of automated agents, store updated state data for the particular resource in the dedicated portion of the memory device allocated to the particular resource; and transmit an address of the dedicated portion of the memory device for the particular resource to the subset of the automated agents, to facilitate asynchronous reading of the stored state data for the particular resource during each training cycle.

In some embodiments, the updated state data for the particular resource includes current state data for the particular resource in an environment in which the resource task requests are made.

In some embodiments, the updated state data for the particular resource further includes historical state data for the particular resource in the environment in which the resource task requests are made.

In some embodiments, the current state data for the particular resource is appended to the historical state data for the particular resource during each training cycle at the dedicated portion of the memory device allocated to the particular resource.

Before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### BRIEF DESCRIPTION OF THE FIGURES

In the Figures, which illustrate example embodiments,

FIG. 1A is a schematic diagram of a computer-implemented system for providing an automated agent, in accordance with an embodiment;

FIG. 1B is a schematic diagram of an automated agent, in accordance with an embodiment;

FIG. 2 is a schematic diagram of an example neural network maintained at the computer-implemented system of FIG. 1A, in accordance with an embodiment;

FIG. 3 is a schematic diagram of a memory management module, in accordance with an embodiment;

FIG. 4 is a flowchart showing example operation of the system of FIG. 1A and the memory management module of FIG. 3, in accordance with an embodiment; and

FIG. 5 is a schematic diagram of a system having a plurality of automated agents, in accordance with an embodiment.

### DETAILED DESCRIPTION

During the process of training reinforcement neural network to optimize or execute resources task requests, transmitting a large amount of state data in real time or near real time during each training cycle can be slow, especially over a TCP/IP internet protocol with multiple automated agents participating in the environment. For example, a machine learning platform implemented using a programming language such as Python tends to have small latencies with inter-process communication, which may impede the automated agents from receiving real time state data and making prompt decision based on the real time state data. The disclosed machine learning platform with a memory management module is configured to speed up the data transmission process during each training cycle for one or more automated agents, each having a respective reinforcement neural network.

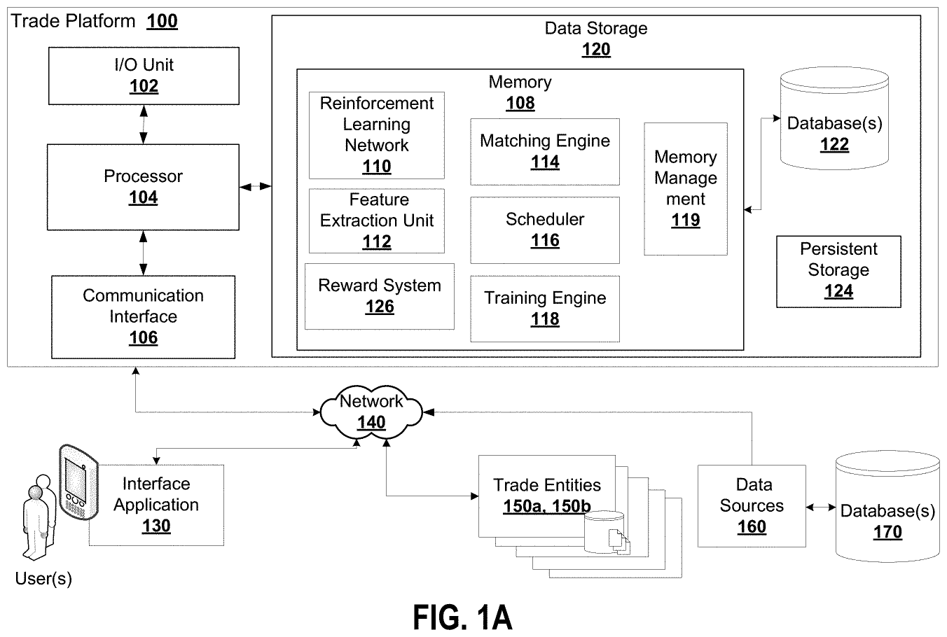

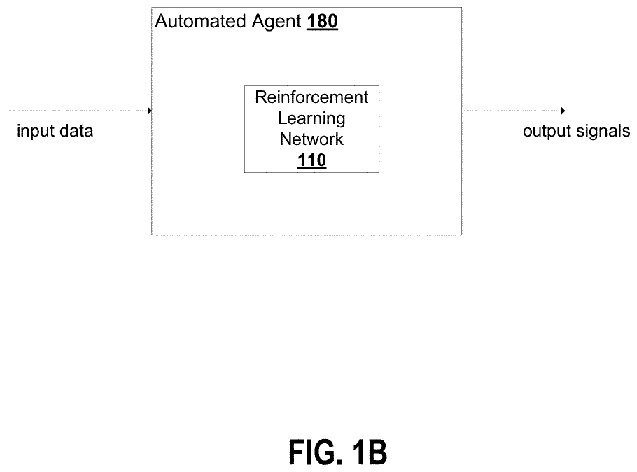

FIG. 1A is a high-level schematic diagram of a computer-implemented system 100 for providing an automated agent having a neural network, in accordance with an embodiment. The automated agent is instantiated and trained by system 100 in manners disclosed herein to generate task requests, which may be referred to as resource task requests.

As detailed herein, in some embodiments, system 100 includes features adapting it to perform certain specialized purposes, e.g., to function as a trading platform. In such embodiments, system 100 may be referred to as trading platform 100 or simply as platform 100 for convenience. In such embodiments, the automated agent may generate requests for tasks to be performed in relation to resources such as securities (e.g., stocks, bonds, options or other negotiable financial instruments). For example, the automated agent may generate requests to trade (e.g., buy and/or sell) securities by way of a trading venue.

Referring now to the embodiment depicted in FIG. 1A, trading platform 100 has data storage 120 storing a model for a reinforcement learning neural network. The model is used by trading platform 100 to instantiate one or more automated agents 180 (FIG. 1B) that each maintain a reinforcement learning neural network 110 (which may be referred to as a reinforcement learning network 110 or network 110 for convenience).

A processor 104 is configured to execute machine-executable instructions to train a reinforcement learning network 110 based on a reward system 126. The reward system generates good (or positive) signals and bad (or negative) signals to train automated agents 180 to perform desired tasks more optimally, e.g., to minimize and maximize certain performance metrics. In some embodiments, an automated agent 180 may be trained by way of signals generated in accordance with reward system 126 to minimize Volume Weighted Average Price (VWAP) slippage. For example, reward system 126 may implement rewards and punishments substantially as described in U.S. patent application Ser. No. 16/426,196, entitled “Trade Platform with Reinforcement Learning”, filed May 30, 2019, the entire contents of which are hereby incorporated by reference herein.

In some embodiments, trading platform 100 can generate reward data by normalizing the differences of the plurality of data values (e.g. VWAP slippage), using a mean and a standard deviation of the distribution.

Throughout this disclosure, it is to be understood that the terms “average” and “mean” refer to an arithmetic mean, which can be obtained by dividing a sum of a collection of numbers by the total count of numbers in the collection.

In some embodiments, trading platform 100 can normalize input data for training the reinforcement learning network 110. The input normalization process can involve a feature extraction unit 112 processing input data to generate different features such as pricing features, volume features, time features, Volume Weighted Average Price features, market spread features. The pricing features can be price comparison features, passive price features, gap features, and aggressive price features. The market spread features can be spread averages computed over different time frames. The Volume Weighted Average Price features can be current Volume Weighted Average Price features and quoted Volume Weighted Average Price features. The volume features can be a total volume of an order, a ratio of volume remaining for order execution, and schedule satisfaction. The time features can be current time of market, a ratio of time remaining for order execution, and a ratio of order duration and trading period length.

The input normalization process can involve computing upper bounds, lower bounds, and a bounds satisfaction ratio; and training the reinforcement learning network using the upper bounds, the lower bounds, and the bounds satisfaction ratio. The input normalization process can involve computing a normalized order count, a normalized market quote and/or a normalized market trade. The platform 100 can have a scheduler 116 configured to follow a historical Volume Weighted Average Price curve to control the reinforcement learning network 110 within schedule satisfaction bounds computed using order volume and order duration.

The platform 100 can connect to an interface application 130 installed on user device to receive input data. Trade entities 150a, 150b can interact with the platform to receive output data and provide input data. The trade entities 150a, 150b can have at least one computing device. The platform 100 can train one or more reinforcement learning neural networks 110. The trained reinforcement learning networks 110 can be used by platform 100 or can be for transmission to trade entities 150a, 150b, in some embodiments. The platform 100 can process trade orders using the reinforcement learning network 110 in response to commands from trade entities 150a, 150b, in some embodiments.

The platform 100 can connect to different data sources 160 and databases 170 to receive input data and receive output data for storage. The input data can represent trade orders. Network 140 (or multiple networks) is capable of carrying data and can involve wired connections, wireless connections, or a combination thereof. Network 140 may involve different network communication technologies, standards and protocols, for example.

The platform 100 can include an I/O unit 102, a processor 104, communication interface 106, and data storage 120. The I/O unit 102 can enable the platform 100 to interconnect with one or more input devices, such as a keyboard, mouse, camera, touch screen and a microphone, and/or with one or more output devices such as a display screen and a speaker.

The processor 104 can execute instructions in memory 108 to implement aspects of processes described herein. The processor 104 can execute instructions in memory 108 to configure a data collection unit, interface unit (to provide control commands to interface application 130), reinforcement learning network 110, feature extraction unit 112, matching engine 114, scheduler 116, training engine 118, memory management module 119, reward system 126, and other functions described herein. The processor 104 can be, for example, any type of general-purpose microprocessor or microcontroller, a digital signal processing (DSP) processor, an integrated circuit, a field programmable gate array (FPGA), a reconfigurable processor, or any combination thereof.

As depicted in FIG. 1B, automated agent 180 receives input data (via a data collection unit) and generates output signal according to its reinforcement learning network 110 for provision to trade entities 150a, 150b. Reinforcement learning network 110 can refer to a neural network that implements reinforcement learning.

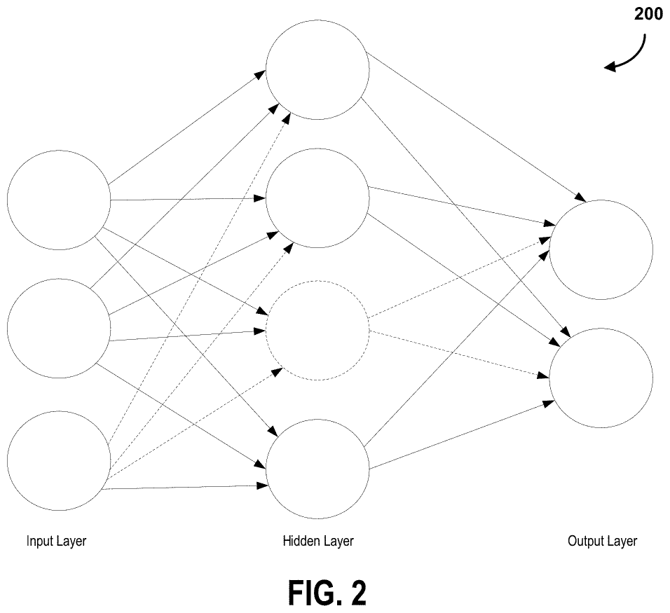

FIG. 2 is a schematic diagram of an example neural network 200, in accordance with an embodiment. The example neural network 200 can include an input layer, one or more hidden layers, and an output layer. The neural network 200 processes input data using its layers based on reinforcement learning, for example.

Reinforcement learning is a category of machine learning that configures agents, such the automated agents 180 described herein, to take actions in an environment to maximize a notion of a reward. The processor 104 is configured with machine executable instructions to instantiate an automated agent 180 that maintains a reinforcement learning neural network 110 (also referred to as a reinforcement learning network 110 for convenience), and to train the reinforcement learning network 110 of the automated agent 180 using a training unit 118.

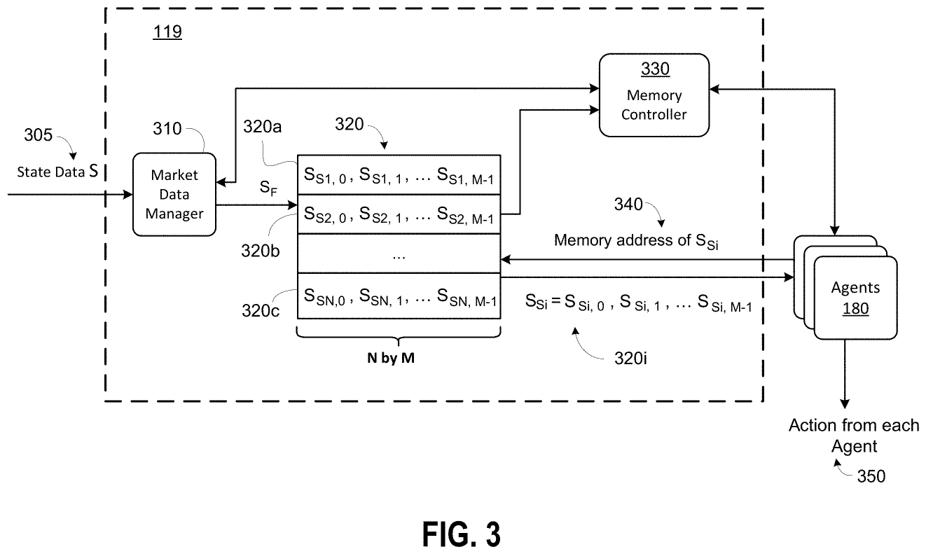

The processor 104 is configured to use the memory management module 119 to facilitate real time or near real time transmission of state data to one or more automated agents 180 efficiently and with minimal delay. As further described in detail below (e.g., FIG. 3), the memory management module 119 includes a local memory device such as a RAM, which is configured to store updated state data from each training cycle of the one or more automated agents 180. The stored state data for a resource (e.g., a security) may include both the current (e.g., the most up-to-date) and historical values of state data for the resource, and there may be a plurality of resources with their respective state data stored on the local memory device. Each automated agent 180 may be configured to receive a location reference (e.g., a memory address or a pointer) for a particular resource relevant during a first training cycle, and uses the location reference in future training cycles to retrieve the updated state data for the particular resource if needed, without having to request the location reference again.

The processor 104 is configured to use the reward system 126 in relation to the reinforcement learning network 110 actions to generate good signals and bad signals for feedback to the reinforcement learning network 110. In some embodiments, the reward system 126 generates good (or positive) signals and bad (or negative) signals to minimize Volume Weighted Average Price slippage, for example. Reward system 126 is configured to receive control the reinforcement learning network 110 to process input data in order to generate output signals. Input data may include trade orders, various feedback data (e.g., rewards), or feature selection data, or data reflective of completed tasks (e.g., executed trades), data reflective of trading schedules, etc. Output signals may include signals for communicating resource task requests, e.g., a request to trade in a certain security. For convenience, a good signal may be referred to as a “positive reward” or simply as a reward, and a bad signal may be referred as a “negative reward” or as a punishment.

Referring again to FIG. 1A, feature extraction unit 112 is configured to process input data to compute a variety of features. The input data can represent a trade order. Example features include pricing features, volume features, time features, Volume Weighted Average Price features, market spread features. These features may be processed to compute state data, which can be a state vector. The state data may be used as input to train an automated agent 180.

Matching engine 114 is configured to implement a training exchange defined by liquidity, counter parties, market makers and exchange rules. The matching engine 114 can be a highly performant stock market simulation environment designed to provide rich datasets and ever changing experiences to reinforcement learning networks 110 (e.g. of agents 180) in order to accelerate and improve their learning. The processor 104 may be configured to provide a liquidity filter to process the received input data for provision to the machine engine 114, for example. In some embodiments, matching engine 114 may be implemented in manners substantially as described in U.S. patent application Ser. No. 16/423,082, entitled “Trade Platform with Reinforcement Learning Network and Matching Engine”, filed May 27, 2019, the entire contents of which are hereby incorporated herein.

Scheduler 116 is configured to follow a historical Volume Weighted Average Price curve to control the reinforcement learning network 110 within schedule satisfaction bounds computed using order volume and order duration.

The interface unit 130 interacts with the trading platform 100 to exchange data (including control commands) and generates visual elements for display at user device. The visual elements can represent reinforcement learning networks 110 and output generated by reinforcement learning networks 110.

Memory 108 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Data storage devices 120 can include memory 108, databases 122, and persistent storage 124.

The communication interface 106 can enable the platform 100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The platform 100 can be operable to register and authenticate users (using a login, unique identifier, and password for example) prior to providing access to applications, a local network, network resources, other networks and network security devices. The platform 100 may serve multiple users which may operate trade entities 150a, 150b.

The data storage 120 may be configured to store information associated with or created by the components in memory 108 and may also include machine executable instructions. The data storage 120 includes a persistent storage 124 which may involve various types of storage technologies, such as solid state drives, hard disk drives, flash memory, and may be stored in various formats, such as relational databases, non-relational databases, flat files, spreadsheets, extended markup files, etc.

A reward system 126 integrates with the reinforcement learning network 110, dictating what constitutes good and bad results within the environment. In some embodiments, the reward system 126 is primarily based around a common metric in trade execution called the Volume Weighted Average Price (“VWAP”). The reward system 126 can implement a process in which VWAP is normalized and converted into the reward that is fed into models of reinforcement learning networks 110. The reinforcement learning network 110 processes one large order at a time, denoted a parent order (i.e. Buy 10000 shares of RY.TO), and places orders on the live market in small child slices (i.e. Buy 100 shares of RY.TO @ 110.00). A reward can be calculated on the parent order level (i.e. no metrics are shared across multiple parent orders that the reinforcement learning network 110 may be processing concurrently) in some embodiments.

To achieve proper learning, the reinforcement learning network 110 is configured with the ability to automatically learn based on good and bad signals. To teach the reinforcement learning network 110 how to minimize VWAP slippage, the reward system 126 provides good and bad signals to minimize VWAP slippage.

The reward system 126 can normalize the reward for provision to the reinforcement learning network 110. The processor 104 is configured to use the reward system 126 to process input data to generate Volume Weighted Average Price data. The input data can represent a parent trade order. The reward system 126 can compute reward data using the Volume Weighted Average Price and compute output data by processing the reward data using the reinforcement learning network 110. In some embodiments, reward normalization may involve transmitting trade instructions for a plurality of child trade order slices based on the generated output data.

FIG. 3 is a schematic diagram of a memory management module 119, in accordance with an embodiment. The memory management module 119 is configured to continuously receive the most up-to-date state data S 305 from an environment in which a plurality of automated agents 180 are participating to generate and execute actions 350, which may be resource task requests. Each state data S 305 may be associated with a particular resource such as a security, which can be, for example, a stock.

At a given point in time tₓ, the state data S 305 may include real time (or near real time) state data for the particular resource (e.g., a stock) at time tₓ obtained from the environment, which may be, for example, a trading venue, a simulated trading environment (e.g., matching engine 114) or indirectly by way of an intermediary. In some embodiments, the state data S 305 can include market data of the particular stock at time tₓ, the market data at time tₓ being generated at least in part due to actions 350 completed in a previous training cycle at a previous time step (e.g., tₓ₋₁) by one or more of the automated agents 180. For example, actions 350 may include resource tasks or trades of the particular stock performed during the previous time step. In this circumstance, the state data S 305 includes values of the particular stock such as prices and volumes of trades.

In some embodiments, a feature extraction unit 112 (see e.g., FIG. 1) of platform 100 may be configured to generate the state data S 305 by processing raw task data relating to at least one trade order of the particular resource from the environment. The state data S 305 can include feature data generated as a consequence of the action 350 by at least one of the agents 180 from a previous time stamp. For example, the state data S 305 may be a state vector including feature data for the particular resource, including but not limited to market data such as pricing, volume, Volume Weighted Average Price, and a market spread.

As an automated agent 180 explores the environment and receives input data from the environment, it learns and adapts its policy or policies over time based on the actions 350 taken by the agent 180, changes in the state data reflective of a state of the environment, and the rewards provided to the agent 180 based on whether its actions 350 achieve desired goals. Such learning and adaption occurs over a series of training cycles.

The state data S 305 may be processed by a market data manager 310, which is configured to format the state data S 305 into an appropriate format and store the formatted state data S_{F} at a specific memory location in a local memory device 320. The state data S 305 and the corresponding formatted state data S_{F} are associated with a particular resource, such as a stock. A stock typically has both current market data and historical market data that are relevant to the training process of the automated agents 180. The formatted state data S_{F} for a particular stock can include a current market data for the stock, appropriately formatted for storage at the memory device 320. To maintain live market data for the particular stock, the market data manager 310 may continue to format and update the market data for the same stock in the same memory location in the local memory device 320 whenever it receives a current state data S 305 for the stock.

In some embodiments, the local memory device 320 may be a RAM device, for example. Storing real time or near real time state data in a local memory device 320 allows separate processes by a number of system components (e.g., agents 180 or memory controller 330) to quickly access the state data, which can be time sensitive for a trading platform, without significant IO overhead and without significant delay, thereby improving the speed, accuracy, performance and efficiency of the learning process of the multiple automated agents 180.

Even though the local memory device 320 is illustrated as part of the memory management module 119, it is to be appreciated that it may be also another part of the memory 108 of the platform 100, which is easily accessible by the automated agents 180 and other system components of the platform 100.

As illustrated in FIG. 3, within the local memory device 320, respective state data for each of a plurality of stocks S1, S2 . . . SN, are stored based on a chronological order. For example, for stock S1, which has a total number of M state data instances stored: the oldest state data is S_{S1, 0}, the next oldest state data is S_{S1, 1}, and the most recent state data stored on the local memory device 320 is S_{S1, M-1}. The array of S_{S1, 0}, S_{S1, 1}, . . . S_{S1, M-1} can be seen as stored at the same memory location 320a.

Similarly, for stock S2, which has a total number of M state data instances stored: the oldest state data is S_{S2, 0}, the next oldest state data is S_{S2, 1}, and the most recent state data stored on the local memory device 320 is S_{S2, M-1}. The array of S_{S2, 0}, S_{S2, 1}, . . . S_{S2, M-1} can be seen as stored at the same memory location 320b.

For stock SN, which has a total number of M state data instances stored: the oldest state data is S_{SN, 0}, the next oldest state data is S_{SN, 1}, and the most recent state data stored on the local memory device 320 is S_{SN, M-1}. The array of S_{SN, 0}, S_{SN, 1}, . . . S_{SN, M-1} can be seen as stored at the same memory location 320c, and so on, so forth.

Even though for ease of illustration, the number of state data instances for the plurality of stocks S1, S2 . . . SN is shown as M, it is to be appreciated that different resources or stocks may each has a different number of state data instances stored on the local memory device 320.

In some embodiments, the market data manager 310 is configured to process the most recent state data S 305 for a stock, e.g., stock Si, into a suitable format, and append the formatted state data S_{F} to the existing array of state data instances for Si, whereby the formatted state data S_{F} becomes the newest member of the state data array for Si, as the last data instance or element of the data array: e.g., S_{Si, 0}, S_{Si, 1}, . . . S_{Si, M-1}, S_{F}.

In some embodiments, a memory controller 330 is configured to send a signal to the market data manger 310 indicating a specific memory location to store an incoming state data S 305. For example, when the state data S 305 is associated with a stock S_{new} that does not have any historical state data stored in the local memory device 320, the memory controller 330 is configured to allocate a dedicated portion of the memory device 320 to store the state data S 305, as well as all future state data instances, for the stock S_{new}. Upon receiving the memory allocation signal from the memory controller 330, the market data manager 310 is configured to store the formatted state data for the state data S 305 at the allocated dedicated portion of the memory device 320, and sends a confirmation back to the memory controller 330 with the specific memory address for the state data of stock S_{new} as stored in the local memory device 320.

During the process of allocating the dedicated portion of the local memory device 320 for storing the state data S of a new stock S_{new}, the memory controller 330 may allocate a memory location that has existing state data of another stock, but one that has been determined to be obsolete for the training of the automated agents 180. In these circumstances, the market data manager 310 may be configured to write the state data S of the new stock S_{new} over the existing state data of the obsolete stock at the allocated memory location, thereby wiping out the existing state data of the obsolete stock.

In some embodiments, the memory controller 330 is configured to keep track of the memory addresses of the corresponding memory location for each of the resources or stocks stored in the memory device 320.

In a training cycle, one or more agents 180 may be provided with state data Sₛᵢ 320i for a stock Si representing at least a current state of the stock in the environment, along with reward data representing a positive or negative reward corresponding to a prior action taken by the respective agent 180 (e.g., a prior task request generated by the agent 180). In a training cycle, responsive to the provided state data Sₛᵢ 320i and the reward data, each of the one or more agents 180 may update its policy and may have opportunity to take a new action 350 (e.g., generate or execute a new resource task request).

The memory controller 330 is configured to send the memory address 340 for the state data of a stock Si to the one or more automated agents 180, which may be a subset of automated agents 180 active in the environment. In some embodiments, the memory controller 330 is configured to only send the memory address 340 for a specific stock Si in response to a request for the specific memory address 340 for the stock Si from the one or more automated agents 180.

Once an agent 180 receives a memory address 340 for the state data of a particular resource or stock from the memory controller 330, it can store the memory address 340 in a local memory and associates the memory address 340 with the particular stock Si, such that the memory controller 330 does not need to send the memory address 340 for the same stock Si to the same agent 180 throughout multiple training cycles during the learning process.

In order to receive the appropriate state data Sₛᵢ 320i of the stock Si relevant for an action or order in a training cycle from the local memory device 320, one or more automated agents 180 may use the same memory address 340 associated with the stock Si to retrieve the appropriate state data Sₛᵢ 320i of the stock Si from the local memory device 320 during the training cycle. That is, asynchronous reading of the stored state data Sₛᵢ 320 of the stock Si by multiple automated agents 180 can be achieved during the same training cycle, as facilitated by a localized memory reading process, thereby reducing system latencies associated with inter-process communication over TCP/IP protocol typically seen in machine learning systems with a large amount of data transmission.

When one or more of the automated agents 180 needs to retrieve the appropriate state data Sₛᵢ 320i of the stock Si relevant for an action or order in process in a training cycle from the local memory device 320, but does not have a memory address yet for the stock Si, the automated agent 180 may request and receive the memory address 340 from the memory controller 330, which keeps track of all memory addresses of state data stored in the local memory device 320.

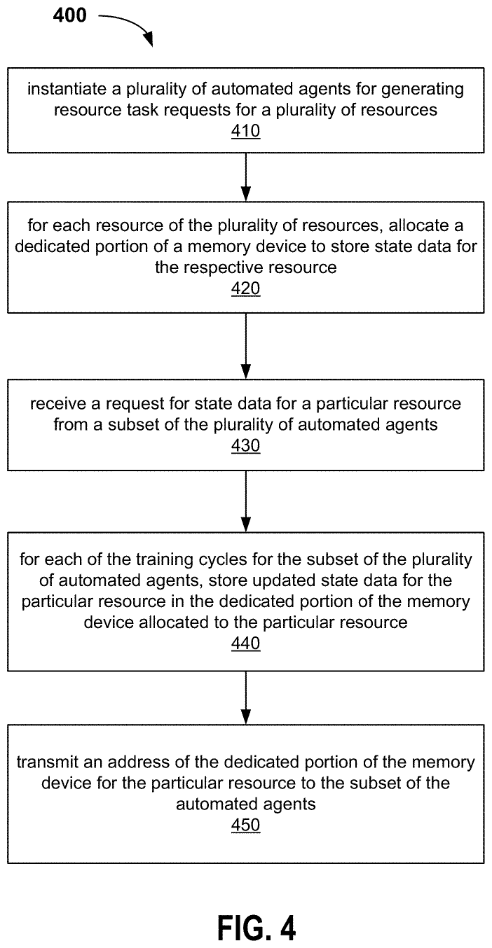

The operation of the platform 100 (including the memory management module 119) is further described with reference to the flowchart depicted in FIG. 4. The platform 100 performs the example operations depicted at blocks 400 and onward, in accordance with an embodiment.

At block 410, the platform 100 instantiates a plurality of automated agents 180, each agent 180 including a respective reinforcement learning neural network 110. Each automated agent 180 provides a policy for generating resource task requests. Training and operation of the automated agent 180 proceeds over a plurality of training cycles.

At block 420, during a given training cycle, the memory controller 330 of the platform 100 allocates a dedicated portion 320a, 320b, 320c of a memory device 320 to store state data for a particular resource identified in one or more of the resource task requests. The resource can be a stock, for example, and the state data S 305 of the stock may include market data such as a market price. For example, at a given point in time tₓ, the state data S 305 may include real time (or near real time) state data for the particular resource (e.g., a stock) at time tₓ obtained from the environment, which may be, for example, a trading venue, a simulated trading environment (e.g., matching engine 114) or indirectly by way of an intermediary.

In some embodiments, the state data S 305 can include market data of the particular stock at time tₓ, the market data at time tₓ being generated at least in part due to actions 350 completed in a previous training cycle at a previous time step (e.g., tₓ₋₁) by one or more of the automated agents 180. For example, actions 350 may include resource tasks or trades of the particular stock performed during the previous time step. In this circumstance, the state data S 305 includes values of the particular stock such as prices and volumes of trades.

The memory controller 330 is configured to send a signal to the market data manger 310 indicating a specific memory location to store an incoming state data S 305 for a resource. For example, when the state data S 305 is associated with a stock S_{new} that does not have any historical state data stored in the local memory device 320, the memory controller 330 is configured to allocate a dedicated portion of the memory device 320 to store the state data S 305, as well as all future state data instances, for the stock S_{new}. Upon receiving the memory allocation signal from the memory controller 330, the market data manager 310 is configured to store the formatted state data for the state data S 305 at the allocated dedicated portion of the memory device 320, and sends a confirmation back to the memory controller 330 with the specific memory address for the state data of stock S_{new} as stored in the local memory device 320.

At block 430, which may be an optional operation, the memory controller 330 receives a request for state data for a particular resource Si from a subset of the plurality of automated agents 180. When one or more of the automated agents 180 needs to retrieve the appropriate state data Sₛᵢ 320i of the stock Si relevant for an action or order in process in a training cycle from the local memory device 320, but does not have a memory address yet for the stock Si, the automated agent 180 may request and receive the memory address 340 from the memory controller 330, which keeps track of all memory addresses of state data stored in the local memory device 320.

At block 440, for each of the training cycles for the subset of the plurality of automated agents 180, the market data manager 310 stores updated state data for the particular resource in the dedicated portion of the memory device 320 allocated to the particular resource by the memory controller 330. In some cases, the market data manager 310 may write the updated state data over existing state data of obsolete resource. Note that blocks 430 and 440 may be performed in parallel, or in no particular order.

In some embodiments, the market data manager 310 processes the updated state data for the particular resource into a specific format for the memory device 320 prior to storing the updated state data in the dedicated portion of the memory device 320 allocated to the particular resource.

In some embodiments, the updated state data for the particular resource may include historical state data for the particular resource in the environment in which the actions, such as resource task requests, are made. The market data manager 310 is configured to append a most recent state data instance, e.g., the formatted state data S_{F}, of the particular resource to the existing (historical) state data stored in the memory device 320, at the same memory location.

At block 450, the memory controller 330 transmits an address 340 of the dedicated portion of the memory device 320 for the particular resource to the subset of the automated agents 180, to facilitate asynchronous reading of the stored state data for the particular resource during each training cycle by the subset of the automated agents 180.

In order to receive the appropriate state data Sₛᵢ 320i of the stock Si relevant for an action or order in a training cycle from the local memory device 320, one or more automated agents 180 may use the same memory address 340 associated with the stock Si to retrieve the appropriate state data Sₛᵢ 320i of the stock Si from the local memory device 320 during the training cycle.

It should be understood that steps of one or more of the blocks depicted in FIG. 4 may be performed in a different sequence or in an interleaved or iterative manner. Further, variations of the steps, omission or substitution of various steps, or additional steps may be considered.

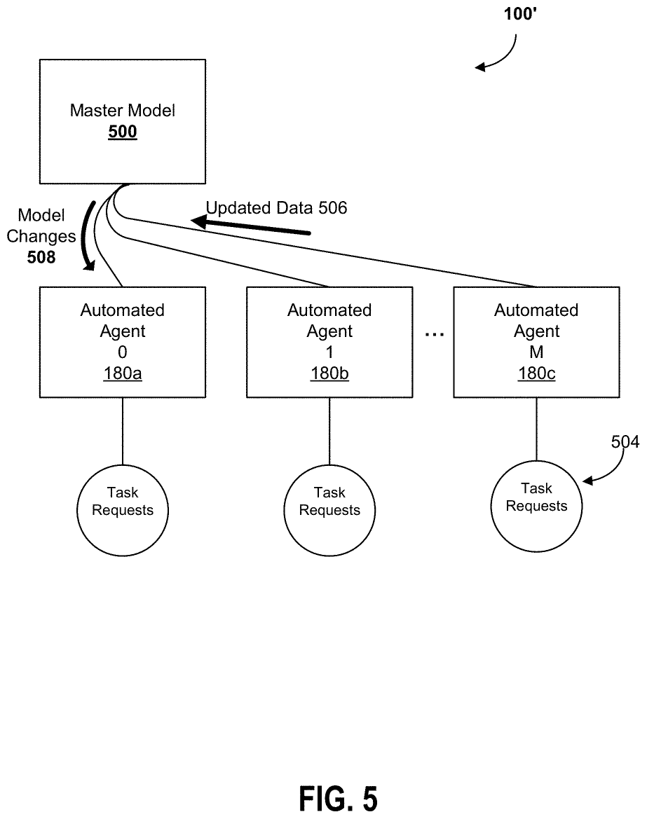

FIG. 5 depicts an embodiment of platform 100′ having a plurality of automated agents 180a, 180b, 180c. In this embodiment, data storage 120 stores a master model 500 that includes data defining a reinforcement learning neural network for instantiating one or more automated agents 180a, 180b, 180c.

During operation, platform 100′ instantiates a plurality of automated agents 180a, 180b, 180c according to master model 500 and each automated agent 180a, 180b, 180c performs operations described herein. For example, each automated agent 180a, 180b, 180c generates tasks requests 504 according to outputs of its reinforcement learning neural network 110.

As the automated agents 180a, 180b, 180c learn during operation, platform 100′ obtains updated data 506 from one or more of the automated agents 180a, 180b, 180c reflective of learnings at the automated agents 180a, 180b, 180c. Updated data 506 includes data descriptive of an “experience” of an automated agent in generating a task request. Updated data 506 may include one or more of: (i) input data, such as state data 305 from FIG. 3, to the given automated agent 180a, 180b, 180c and any applied normalizations, (ii) a list of possible resource task requests evaluated by the given automated agent with associated probabilities of making each requests, and (iii) one or more rewards for generating a task request.

Platform 100′ processes updated data 506 to update master model 500 according to the experience of the automated agent 180a, 180b, 180c providing the updated data 506. Consequently, automated agents 180a, 180b, 180c instantiated thereafter will have benefit of the learnings reflected in updated data 506. Platform 100′ may also sends model changes 508 to the other automated agents 180a, 180b, 180c so that these pre-existing automated agents 180a, 180b, 180c will also have benefit of the learnings reflected in updated data 506. In some embodiments, platform 100′ sends model changes 508 to automated agents 180a, 180b, 180c in quasi-real time, e.g., within a few seconds, or within one second. In one specific embodiment, platform 100′ sends model changes 508 to automated agents 180a, 180b, 180c using a stream-processing platform such as Apache Kafka, provided by the Apache Software Foundation. In some embodiments, platform 100′ processes updated data 506 to optimize expected aggregate reward across based on the experiences of a plurality of automated agents 180a, 180b, 180c.

In some embodiments, platform 100′ obtains updated data 506 after each time step. In other embodiments, platform 100′ obtains updated data 506 after a predefined number of time steps, e.g., 2, 5, 10, etc. In some embodiments, platform 100′ updates master model 500 upon each receipt updated data 506. In other embodiments, platform 100′ updates master model 500 upon reaching a predefined number of receipts of updated data 506, which may all be from one automated agent or from a plurality of automated agents 180a, 180b, 180c.

In one example, platform 100′ instantiates a first automated agent 180a, 180b, 180c and a second automated agent 180a, 180b, 180c, each from master model 500. Platform 100′ obtains updated data 506 from the first automated agents 180a, 180b, 180c. Platform 100′ modifies master model 500 in response to the updated data 506 and then applies a corresponding modification to the second automated agent 180a, 180b, 180c. Of course, the roles of the automated agents 180a, 180b, 180c could be reversed in another example such that platform 100′ obtains updated data 506 from the second automated agent 180a, 180b, 180c and applies a corresponding modification to the first automated agent 180a, 180b, 180c.

In some embodiments of platform 100′, an automated agent may be assigned all tasks for a parent order. In other embodiments, two or more automated agent 500 may cooperatively perform tasks for a parent order; for example, child slices may be distributed across the two or more automated agents 180a, 180b, 180c.

In the depicted embodiment, platform 100′ may include a plurality of I/O units 102, processors 104, communication interfaces 106, and memories 108 distributed across a plurality of computing devices. In some embodiments, each automated agent may be instantiated and/or operated using a subset of the computing devices. In some embodiments, each automated agent may be instantiated and/or operated using a subset of available processors or other compute resources. Conveniently, this allows tasks to be distributed across available compute resources for parallel execution. Other technical advantages include sharing of certain resources, e.g., data storage of the master model, and efficiencies achieved through load balancing. In some embodiments, number of automated agents 180a, 180b, 180c may be adjusted dynamically by platform 100′. Such adjustment may depend, for example, on the number of parent orders to be processed. For example, platform 100′ may instantiate a plurality of automated agents 180a, 180b, 180c in response to receive a large parent order, or a large number of parent orders. In some embodiments, the plurality of automated agents 180a, 180b, 180c may be distributed geographically, e.g., with certain of the automated agent 180a, 180b, 180c placed for geographic proximity to certain trading venues.

In some embodiments, the operation of platform 100′ adheres to a master-worker pattern for parallel processing. In such embodiments, each automated agent 180a, 180b, 180c may function as a “worker” while platform 100′ maintains the “master” by way of master model 500.

Platform 100′ is otherwise substantially similar to platform 100 described herein and each automated agent 180a, 180b, 180c is otherwise substantially similar to automated agent 180 described herein.

Pricing Features: In some embodiments, input normalization may involve the training engine 118 computing pricing features. In some embodiments, pricing features for input normalization may involve price comparison features, passive price features, gap features, and aggressive price features.

Price Comparing Features: In some embodiments, price comparison features can capture the difference between the last (most current) Bid/Ask price and the Bid/Ask price recorded at different time intervals, such as 30 minutes and 60 minutes ago: qt_Bid30, qt_Ask30, qt_Bid60, qt_Ask60. A bid price comparison feature can be normalized by the difference of a quote for a last bid/ask and a quote for a bid/ask at a previous time interval which can be divided by the market average spread. The training engine 118 can “clip” the computed values between a defined ranged or clipping bound, such as between −1 and 1, for example. There can be 30 minute differences computed using clipping bound of −5, 5 and division by 10, for example.

An Ask price comparison feature (or difference) can be computed using an Ask price instead of Bid price. For example, there can be 60-minute differences computed using clipping bound of −10, 10 and division by 10.

Passive Price: The passive price feature can be normalized by dividing a passive price by the market average spread with a clipping bound. The clipping bound can be 0, 1, for example.

Gap: The gap feature can be normalized by dividing a gap price by the market average spread with a clipping bound. The clipping bound can be 0, 1, for example.

Aggressive Price: The aggressive price feature can be normalized by dividing an aggressive price by the market average spread with a clipping bound. The clipping bound can be 0, 1, for example.

Volume and Time Features: In some embodiments, input normalization may involve the training engine 118 computing volume features and time features. In some embodiments, volume features for input normalization involves a total volume of an order, a ratio of volume remaining for order execution, and schedule satisfaction. In some embodiments, the time features for input normalization involves current time of market, a ratio of time remaining for order execution, and a ratio of order duration and trading period length.

Ratio of Order Duration and Trading Period Length: The training engine 118 can compute time features relating to order duration and trading length. The ratio of total order duration and trading period length can be calculated by dividing a total order duration by an approximate trading day or other time period in seconds, minutes, hours, and so on. There may be a clipping bound.

Current Time of the Market: The training engine 118 can compute time features relating to current time of the market. The current time of the market can be normalized by the different between the current market time and the opening time of the day (which can be a default time), which can be divided by an approximate trading day or other time period in seconds, minutes, hours, and so on.

Total Volume of the Order: The training engine 118 can compute volume features relating to the total order volume. The training engine 118 can train the reinforcement learning network 110 using the normalized order count. The total volume of the order can be normalized by dividing the total volume by a scaling factor (which can be a default value).

Ratio of time remaining for order execution: The training engine 118 can compute time features relating to the time remaining for order execution. The ratio of time remaining for order execution can be calculated by dividing the remaining order duration by the total order duration. There may be a clipping bound.

Ratio of volume remaining for order execution: The training engine 118 can compute volume features relating to the remaining order volume. The ratio of volume remaining for order execution can be calculated by dividing the remaining volume by the total volume. There may be a clipping bound.

Schedule Satisfaction: The training engine 118 can compute volume and time features relating to schedule satisfaction features. This can give the model a sense of how much time it has left compared to how much volume it has left. This is an estimate of how much time is left for order execution. A schedule satisfaction feature can be computed the a different of the remaining volume divided by the total volume and the remaining order duration divided by the total order duration. There may be a clipping bound.

VWAPs Features: In some embodiments, input normalization may involve the training engine 118 computing Volume Weighted Average Price features. In some embodiments, Volume Weighted Average Price features for input normalization may involve computing current Volume Weighted Average Price features and quoted Volume Weighted Average Price features.

Current VWAP: Current VWAP can be normalized by the current VWAP adjusted using a clipping bound, such as between −4 and 4 or 0 and 1, for example.

Quote VWAP: Quote VWAP can be normalized by the quoted VWAP adjusted using a clipping bound, such as between −3 and 3 or −1 and 1, for example.

Market Spread Features In some embodiments, input normalization may involve the training engine 118 computing market spread features. In some embodiments, market spread features for input normalization may involve spread averages computed over different time frames.

Several spread averages can be computed over different time frames according to the following equations.

Spread average: Spread average can be the difference between the bid and the ask on the exchange (e.g., on average how large is that gap). This can be the general time range for the duration of the order. The spread average can be normalized by dividing the spread average by the last trade price adjusted using a clipping bound, such as between 0 and 5 or 0 and 1, for example.

Spread σ: Spread σ can be the bid and ask value at a specific time step. The spread can be normalized by dividing the spread by the last trade price adjusted using a clipping bound, such as between 0 and 2 or 0 and 1, for example.

Bounds and Bounds Satisfaction In some embodiments, input normalization may involve computing upper bounds, lower bounds, and a bounds satisfaction ratio. The training engine 118 can train the reinforcement learning network 110 using the upper bounds, the lower bounds, and the bounds satisfaction ratio.

Upper Bound: Upper bound can be normalized by multiplying an upper bound value by a scaling factor (such as 10, for example).

Lower Bound: Lower bound can be normalized by multiplying a lower bound value by a scaling factor (such as 10, for example).

Bounds Satisfaction Ratio: Bounds satisfaction ratio can be calculated by a difference between the remaining volume divided by a total volume and remaining order duration divided by a total order duration, and the lower bound can be subtracted from this difference. The result can be divided by the difference between the upper bound and the lower bound. As another example, bounds satisfaction ratio can be calculated by the difference between the schedule satisfaction and the lower bound divided by the difference between the upper bound and the lower bound.

Queue Time: In some embodiments, platform 100 measures the time elapsed between when a resource task (e.g., a trade order) is requested and when the task is completed (e.g., order filled), and such time elapsed may be referred to as a queue time. In some embodiments, platform 100 computes a reward for reinforcement learning neural network 110 that is positively correlated to the time elapsed, so that a greater reward is provided for a greater queue time. Conveniently, in such embodiments, automated agents may be trained to request tasks earlier which may result in higher priority of task completion.

Orders in the Order Book: In some embodiments, input normalization may involve the training engine 118 computing a normalized order count or volume of the order. The count of orders in the order book can be normalized by dividing the number of orders in the order book by the maximum number of orders in the order book (which may be a default value). There may be a clipping bound.

In some embodiments, the platform 100 can configured interface application 130 with different hot keys for triggering control commands which can trigger different operations by platform 100.

One Hot Key for Buy and Sell: In some embodiments, the platform 100 can configured interface application 130 with different hot keys for triggering control commands. An array representing one hot key encoding for Buy and Sell signals can be provided as follows:

Buy: [1, 0]

Sell: [0, 1]

One Hot Key for action: An array representing one hot hey encoding for task actions taken can be provided as follows:

Pass: [1, 0, 0, 0, 0, 0]

Aggressive: [0, 1, 0, 0, 0, 0,]

Top: [0, 0, 1, 0, 0, 0]

Append: [0, 0, 0, 1, 0, 0]

Prepend: [0, 0, 0, 0, 1, 0]

Pop: [0, 0, 0, 0, 0, 1]

In some embodiments, other task actions that can be requested by an automated agent include:

Far touch—go to ask

Near touch—place at bid

Layer in—if there is an order at near touch, order about near touch

Layer out—if there is an order at far touch, order close far touch

Skip—do nothing

Cancel—cancel most aggressive order

In some embodiments, the fill rate for each type of action is measured and data reflective of fill rate is included in task data received at platform 100.

In some embodiments, input normalization may involve the training engine 118 computing a normalized market quote and a normalized market trade. The training engine 118 can train the reinforcement learning network 110 using the normalized market quote and the normalized market trade.

Market Quote: Market quote can be normalized by the market quote adjusted using a clipping bound, such as between −2 and 2 or 0 and 1, for example.

Market Trade: Market trade can be normalized by the market trade adjusted using a clipping bound, such as between −4 and 4 or 0 and 1, for example.

Spam Control: The input data for automated agents 180 may include parameters for a cancel rate and/or an active rate.

Scheduler: In some embodiment, the platform 100 can include a scheduler 116. The scheduler 116 can be configured to follow a historical Volume Weighted Average Price curve to control the reinforcement learning network 110 within schedule satisfaction bounds computed using order volume and order duration. The scheduler 116 can compute schedule satisfaction data to provide the model or reinforcement learning network 110 a sense of how much time it has in comparison to how much volume remains. The schedule satisfaction data is an estimate of how much time is left for the reinforcement learning network 110 to complete the requested order or trade. For example, the scheduler 116 can compute the schedule satisfaction bounds by looking at a different between the remaining volume over the total volume and the remaining order duration over the total order duration.

In some embodiments, automated agents may train on data reflective of trading volume throughout a day, and the generation of resource requests by such automated agents need not be tied to historical volumes. For example, conventionally, some agent upon reaching historical bounds (e.g., indicative of the agent falling behind schedule) may increase aggression to stay within the bounds, or conversely may also increase passivity to stay within bounds, which may result in less optimal trades.

The scheduler 116 can be configured to follow a historical VWAP curve. The difference is that he bounds of the scheduler 116 are fairly high, and the reinforcement learning network 110 takes complete control within the bounds.

The foregoing discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

The embodiments and examples described herein are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

Of course, the above described embodiments are intended to be illustrative only and in no way limiting. The described embodiments are susceptible to many modifications of form, arrangement of parts, details and order of operation. The disclosure is intended to encompass all such modification within its scope, as defined by the claims.

1. A computer-implemented system for training an automated agent, the system comprising:
a communication interface;
at least one processor;
memory in communication with the at least one processor; and
software code stored in the memory, which when executed at the at least one processor causes the system to:
instantiate a plurality of automated agents for generating resource task requests for a plurality of resources, each of the automated agents configured to train over a plurality of training cycles;
for each resource of the plurality of resources, allocate a dedicated portion of a memory device to store state data for the respective resource;
receive a request for state data for a particular resource from a subset of the plurality of automated agents;
for each of the training cycles for the subset of the plurality of automated agents, store updated state data for the particular resource in the dedicated portion of the memory device allocated to the particular resource; and
transmit an address of the dedicated portion of the memory device for the particular resource to the subset of the automated agents, to facilitate asynchronous reading of the stored state data for the particular resource during each training cycle.

2. The computer-implemented system of claim 1, wherein the updated state data for the particular resource comprises current state data for the particular resource in an environment in which the resource task requests are made.

3. The computer-implemented system of claim 2, wherein the updated state data for the particular resource further comprises historical state data for the particular resource in the environment in which the resource task requests are made.

4. The computer-implemented system of claim 3, wherein the current state data for the particular resource is appended to the historical state data for the particular resource during each training cycle at the dedicated portion of the memory device allocated to the particular resource.

5. The computer-implemented system of claim 1, wherein the software code, when executed at the at least one processor further causes the system to:
process the updated state data for the particular resource into a specific format for the memory device prior to storing the updated state data in the dedicated portion of the memory device allocated to the particular resource.

6. The computer-implemented system of claim 1, wherein the software code, when executed at the at least one processor causes the system to:
store updated state data for each of the plurality of resources in the dedicated portion of the memory device to for the respective resource.

7. The computer-implemented system of claim 2, wherein the current state data for the particular resource includes a market price of the particular resource.

8. The computer-implemented system of claim 7, wherein the environment includes at least one trading venue.

9. A computer-implemented method for training an automated agent, the method comprising:
instantiating a plurality of automated agents for generating resource task requests for a plurality of resources, each of the automated agents configured to train over a plurality of training cycles;
for each resource of the plurality of resources, allocating a dedicated portion of a memory device to store state data for the respective resource;
receiving a request for state data for a particular resource from a subset of the plurality of automated agents;
for each of the training cycles for the subset of the plurality of automated agents, storing updated state data for the particular resource in the dedicated portion of the memory device allocated to the particular resource; and
transmitting an address of the dedicated portion of the memory device for the particular resource to the subset of the automated agents, to facilitate asynchronous reading of the stored state data for the particular resource during each training cycle.

10. The method of claim 9, wherein the updated state data for the particular resource comprises current state data for the particular resource in an environment in which the resource task requests are made.

11. The method of claim 10, wherein the updated state data for the particular resource further comprises historical state data for the particular resource in the environment in which the resource task requests are made.

12. The method of claim 11, wherein storing updated state data for the particular resource in the dedicated portion of the memory device comprises appending the current state data for the particular resource to the historical state data for the particular resource during each training cycle at the dedicated portion of the memory device allocated to the particular resource.

13. The method of claim 9, further comprising, prior to storing the updated state data in the dedicated portion of the memory device allocated to the particular resource:
processing the updated state data for the particular resource into a specific format for the memory device.

14. The method of claim 9, comprising:
storing updated state data for each of the plurality of resources in the dedicated portion of the memory device to for the respective resource.

15. The method of claim 10, wherein the current state data for the particular resource includes a market price of the particular resource.

16. The method of claim 15, wherein the environment includes at least one trading venue.

17. A non-transitory computer-readable storage medium storing instructions which when executed adapt at least one computing device to:
instantiate a plurality of automated agents for generating resource task requests for a plurality of resources, each of the automated agents configured to train over a plurality of training cycles;
for each resource of the plurality of resources, allocate a dedicated portion of a memory device to store state data for the respective resource;
receive a request for state data for a particular resource from a subset of the plurality of automated agents;
for each of the training cycles for the subset of the plurality of automated agents, store updated state data for the particular resource in the dedicated portion of the memory device allocated to the particular resource; and
transmit an address of the dedicated portion of the memory device for the particular resource to the subset of the automated agents, to facilitate asynchronous reading of the stored state data for the particular resource during each training cycle.

18. The non-transitory computer-readable storage medium of claim 17, wherein the updated state data for the particular resource comprises current state data for the particular resource in an environment in which the resource task requests are made.

19. The non-transitory computer-readable storage medium of claim 18, wherein the updated state data for the particular resource further comprises historical state data for the particular resource in the environment in which the resource task requests are made.

20. The non-transitory computer-readable storage medium of claim 19, wherein the current state data for the particular resource is appended to the historical state data for the particular resource during each training cycle at the dedicated portion of the memory device allocated to the particular resource.
